(19) United States
(12) Patent Application Publication
(10) Pub. No.: US 2017/0287067 A1
(43) Pub. Date: Oct. 5, 2017

(54) SYSTEM AND METHOD FOR IMPROVING BROKERAGE TRANSACTIONS

(71) Applicant: Agentsdeal Inc., San Jose, CA (US)

(72) Inventor: Sandeep K Gupta, San Jose, CA (US)

(73) Assignee: Agentsdeal Inc., San Jose, CA (US)

(21) Appl. No.: 15/472,240

(22) Filed: Mar. 28, 2017

Related U.S. Application Data
(60) Provisional application No. 62/315,124, filed on Mar. 30, 2016.

(51) Int. Cl. G06Q 40/04

(52) U.S. Cl. CPC G06Q 40/04

(57) ABSTRACT

Embodiments for methods, systems and apparatuses for improving brokerage transactions through a server are disclosed. In one aspect, the method includes receiving, input by a user, relevant data, storing the relevant data in a database, and identifying a plurality of agents from a list of agents by using the relevant data. The method further includes receiving at least two bids associated with at least one agent of the identified plurality of agents, and each bid includes at least one of: commission charged to user or commission rebate to user. The method further includes providing the at least two bids associated with the at least one of the identified plurality of agents to the user.

### RELATED APPLICATIONS

This patent application claims priority to US Provisional Patent Application No. 62/315,124 filed on Mar. 30, 2016, which is herein incorporated by reference.

### FIELD OF THE DESCRIBED EMBODIMENTS

The described embodiments relate generally to brokerage transactions. More particularly, the described embodiments relate to systems, methods, and apparatuses to improve brokerage transactions.

### BACKGROUND

The present invention relates to improving brokerage transactions that may be applicable to real estate transactions and any other transactions requiring a “middleman/agent” between two users or “principals.” More particularly, this invention relates to systems and methods for users, usually principals who desire to purchase or sell property in a brokerage transaction, to identify and solicit bids from agents, usually listing agents, working under a licensed listing broker, or selling agents, working under a licensed selling broker. Traditionally, agents have a great deal of difficulty locating users, or buyers and sellers, who are serious about participation in the market. This is one of the reasons that lead to high commission rates in real estate transactions. Similarly, users experience difficulty when trying to locate agents for their market needs. Further, users have limited resources with which to compare a variety of agents, and no discernible way to gauge if a given agent is experienced in the user's particular brokerage transaction. While routine and conventional solutions exist, such as Multiple Listing Services (MLS), help-u-sell, other brokerages, and even agent-finder websites trying to connect the agent to users have surfaced; these solutions have not solved the problem of inflated commission rates associated with brokerage transactions, nor correlated any discounted commissions with factors such as: the exact services offered or performed, the experience level of the agent, or the expertise of the agent.

Another great difficulty is rooted in the limitations of the physical world. For example, if a user wishes to engage in brokerage transactions from a distant location, the traditional methods of selecting an agent far away, such as the telephone and postal services or other solutions, are extremely limited in speed, availability, and depth, of information. Further, it can take a prohibitive amount of time for a user to be able to discover an agent that will meet the user's needs, such as criterion of experience, commission refund, and services performed by the agent. As a result, users frequently lower their expectations and requirements.

Further, transactions through a broker are typically a time consuming processes for a user seeking to minimize costs of agents required to handle the transactions. Typically, the user must manually seek out individual agents (via phone, e-mail, personal visits, etc.) one at a time in order to obtain commission estimates for listing the property to be sold (or commission refunds to user from commission obtained by agent from seller, to find appropriate properties to buy) and then the user must individually negotiate the terms for services to be provided by the agent, including hours spent researching markets, number of days to list property, advertising, open houses, and credit checks of potential buyers, among many other services. This process is particularly arduous for a user who is not accustomed to negotiating or who does not have the time to contact respective brokers. Often users who are first or second time buyers do not even have the knowledge or the expertise to be able to even identify the services needed behind the task of buying or selling a home from an agent.

Additionally, users, unless they are very savvy, usually cannot negotiate commissions based on the service levels provided by agents due to the complexity of brokerage transactions. It becomes almost practically impossible for a user to negotiate fine details of a brokerage transaction if that same service level negotiation has to be done with a large number of agents (>10) to realize a “market rate” for such services. Further, due to the many possible goods and services provided by agents, it is difficult to impossible for a user to compare and contrast commission rates between agents due to variance of the many goods and services offered by each agent. For example, it is difficult to compare and correlate the commission refund/discount with the experience level of the agent. A user would need to contact a very large number of agents (sometimes exceeding even 50) to identify agents with similar level of experience or similar levels of “user reviews” whose commission refund/discount can then be compared, which is not practical. All of the above are some of the reasons that high commission rates have persisted for decades, as user time limitation causes them to select particular word of mouth referrals from other people they know or have heard of, without “auctioning” or bringing such commission to a market rate based on either of expertise of similar agents or service levels offered by similar agents. The fear of “you get what you pay for” has persisted and needs to be solved.

Finally, users often are not aware that agents typically do not charge the same commission rates or ask for the same number of listing days. Like any other business, agents may have a slow period, or sector of operation, and therefore be willing to reduce their commission rates at specific times or in specific areas. But agents willing to reduce their commission rate will likely only do so anonymously so that they can privately lower their prices only for a period of time, in a certain area, or for a particular transaction. An agent is not likely to publicly advertise a reduced commission rate to avoid competition among other agents in a given market, or inhibiting the agent from later charging a higher rate to another user within the same market. Thus, a user who does not manually seek out agents to negotiate a reduced rate typically agrees to pay a current market commission rate for listing a property to sell as high as 5% or 7%.

Therefore, a need has long existed for a method and system that overcome the problems noted above and others previously experienced.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description,” taken in conjunction with the accompanying drawings, illustrating by way of example the principles of the described embodiments, one will understand how the aspects of various implementations are used to enable improvement of brokerage transactions.

### BRIEF DESCRIPTION OF THE DRAWINGS

In order that the present disclosure can be understood in greater detail, a more particular description may be had by reference to the features of various embodiments, some of which are illustrated in the appended drawings. The appended drawings, however, merely illustrate the more pertinent features of the present disclosure and are therefore not to be considered limiting, for the description may admit to other effective features.

FIG. 1 shows a computer system that facilitates improving brokerage transactions, in accordance with some embodiments.

FIGS. 2A-2B illustrate a flowchart representation of a method of improving a brokerage transaction, in accordance with some embodiments.

FIGS. 3A-3B illustrate exemplar graphical representations of different tiers of service in a given brokerage transaction, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device.

### DETAILED DESCRIPTION

The various implementations described herein include systems, methods and/or devices used to improve brokerage transactions. Some implementations include systems, methods and/or devices to gather and store data input by a user, analyze that data in order to identify appropriate agents for the brokerage transaction, and output notifications to those agents in order to elicit bidding for selection by user. In some embodiments the systems, methods, and/or devices determine a sufficiency score for the identified agents, and more agents are identified if the sufficiency score falls below a threshold. In some embodiments the elicited bids are in turn output to the agents in order to facilitate an “open auction” platform. In other embodiments agents are able to place bids that correlate to tiered levels of service. In some embodiments the tier of service can be flexible, such that a given bid can include a sliding scale of payment to be determined at the close of a brokerage transaction, based on what work the agent has actually performed; a “pay for what you get” model. In other embodiments the systems, methods and/or devices store characteristics of brokerage transactions in order to analyze the characteristics to improve functionality of data gathering, analysis, and output described herein.

More specifically, some implementations include a system to improve brokerage transactions. In some implementations, the system includes a server electronically connected to a database, the server operative to receive relevant data input by a user, store the relevant data, and use that relevant data to identify a first plurality of agents from a list of agents. The system further includes the server being operative to receive at least two bids associated with at least one of the agents identified in the first plurality of agents, wherein each bid is correlated to a tier of a plurality of tiers and each bid contains at least one of: commission charged to user or commission rebate to user. The system further includes providing the at least two bids associated with the at least one of the identified first plurality of agents to the user.

In some embodiments, the system further includes the server being configured to provide the at least two bids associated with the at least one of the identified first plurality of agents to the identified first plurality of agents.

In some embodiments, the system further includes the server being configured to store characteristics of the brokerage transactions in the database and utilize machine learning to change the correlated tier of the plurality of tiers based on analysis of the stored characteristics of brokerage transactions.

In some embodiments, at least one bid, of the received at least two bids, includes more than one tier, wherein upon completion of the brokerage transactions, the tier is determined according to services actually provided by the agent.

In some embodiments, the system is further configured to receive a first selection from the user, the first selection correlating to one or more bids of the at least two bids associated with at least one of the identified first plurality of agents. The system is further configured to notify the at least one of the plurality of agents associated with the one or more bids correlated to the first selection.

In some embodiments, the system performs the steps of: identifying the first plurality; receiving the at least two bids; providing the at least two bids to the user, and receiving the first selection; and notifying the at least one of the plurality of agents within a time limit.

In some embodiments, specified information, of the at least one of the plurality of agents associated with the one or more bids correlated to the first selection, is provided to the user.

In some embodiments, the first selection may be followed by a second selection correlating to one or more bids of the at least two bids associated with at least one of the identified first plurality of agents.

In some embodiments, the system is further configured to determine a sufficiency score for each agent of the identified first plurality of agents, and identify a second plurality of agents from the list of agents if the determined sufficiency score of a predetermined number of agents of the identified first plurality of agents does not exceed a threshold.

In some embodiments, pluralities of agents are repeatedly identified until a predetermined number of agents of an identified plurality of agents exceeds the threshold.

In some embodiments, the system stores characteristics of the brokerage transactions in the database. In other embodiments the sufficiency score threshold is changed based on analysis of stored characteristics of the brokerage transactions.

In some embodiments, identifying the first plurality of agents is further based upon a registration status of agents in the list of agents. In some embodiments, identifying the first plurality of agents is further based upon an associated score of each agent in the list of agents.

In some embodiments, providing the at least two bids associated with the at least one of the identified first plurality of agents to the user includes ranking the at least two bids according to an associated score of each agent in the list of agents.

In some embodiments, the associated score of each agent is calculated by including each agent's number of brokerage transactions completed in one or more predetermined windows of time.

In some embodiments, the system provides the user an expected bid range, wherein the expected bid range is based on analysis of at least one of: the first relevant data and the stored characteristics of the brokerage transactions; and the system is further configured to allow the user to modify the first relevant data. In another aspect, any of the systems described above are performed by computer-method including receiving, input by a user, first relevant data; storing the first relevant data in a database; identifying, using the first relevant data, a first plurality of agents from a list of agents; receiving at least two bids associated with at least one of the identified first plurality of agents, wherein each bid is correlated to a tier of a plurality of tiers and each bid includes at least one of: commission charge to user or commission rebate to user; and providing the at least two bids associated with the at least one of the identified first plurality of agents to the user.

In some embodiments the computer-method includes performing any of the system functions described above.

In yet another aspect, a non-transitory computer readable storage medium, storing one or more programs for execution by one or more processors of a server, including a brokerage improvement module, the one or more programs including instructions for performing any of the system functions described above.

Another embodiment includes a system to improve brokerage transactions that includes a server electronically connected to a database, the server operative to receive relevant data input by a user, store the relevant data, and use that relevant data to identify a first plurality of agents from a list of agents. The system includes the server being operative to receive at least two bids associated with at least one of the agents identified in the first plurality of agents, each bid containing at least one of: commission charged to user and commission rebate to user. The system further includes providing the at least two bids associated with the at least one of the identified first plurality of agents to the identified first plurality of agents; and providing the at least two bids associated with the at least one of the identified first plurality of agents to the user. In other embodiments the system is further configured to perform any of the functions described above.

It is noted that the goal of having users to select agents to improve brokerage transactions can result in an oral or written contract at various points of time, at receiving first or second or subsequent selection of agent bid, in various embodiments described herein, and others not described.

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

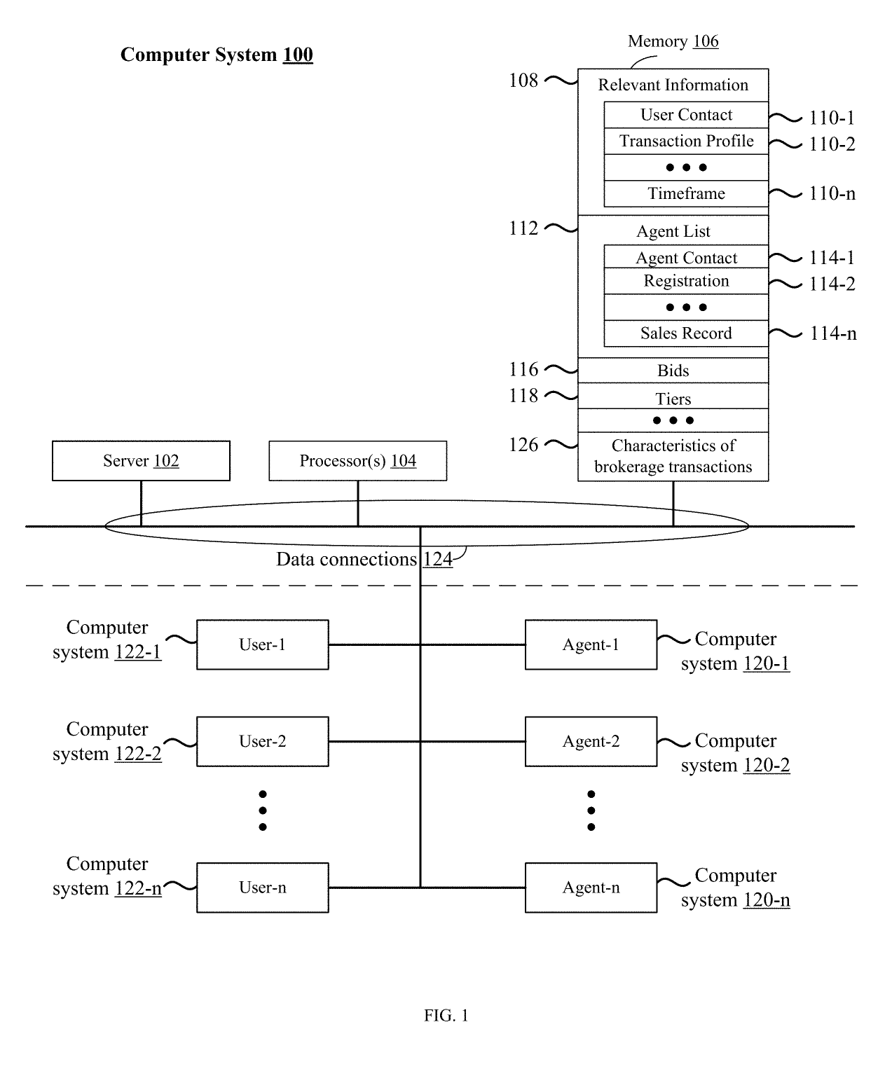

FIG. 1 is a block diagram illustrating an implementation of a computer system 100, in accordance with some embodiments. While some example features are illustrated, various other features have not been illustrated for the sake of brevity and so as not to obscure more pertinent aspects of the example implementations disclosed herein. To that end, as a non-limiting example, computer system 100 includes a server 102, which is electronically coupled through data connections 124 to processor(s) 104, and memory 106. Further, it is understood that data connections 124 include coupling to computer systems 122-1 through 122-n, and 120-1 through 120-n (e.g., user-1 through user-n, and agent-1, through agent-n can all send to and receive data from computer system 100 via data connections 124). In some implementations computer systems 122-1 through 122-n, and 120-1 through 120-n are external devices with their own processors and memory, in other implementations they can be modules implemented within computer system 100. In some implementations, memory 106 includes non-volatile memory (e.g., NAND-type flash memory or NOR-type flash memory). Further, in some implementations, memory 106 includes a solid-state drive (SSD). However, memory 106 can include one or more other types of storage media in accordance with aspects of a wide variety of implementations.

Computer system 100 is coupled to memory 106 through data connections 124. However, in some implementations computer system 100 includes memory 106 as a component and/or sub-system. Computer system 100 may be any suitable computer device, such as a personal computer, a workstation, a computer server, or any other computing device. Computer system 100 is sometimes called a host or host system. In some implementations, computer system 100 includes one or more processors 104, one or more types of memory 106, optionally includes a display and/or other user interface components such as a keyboard, a touch screen display, a mouse, a track-pad, a digital camera and/or any number of supplemental devices to add functionality. In some implementations, computer system 100 is a server system, such as a server system in a data center, and does not have a display and other user interface components.

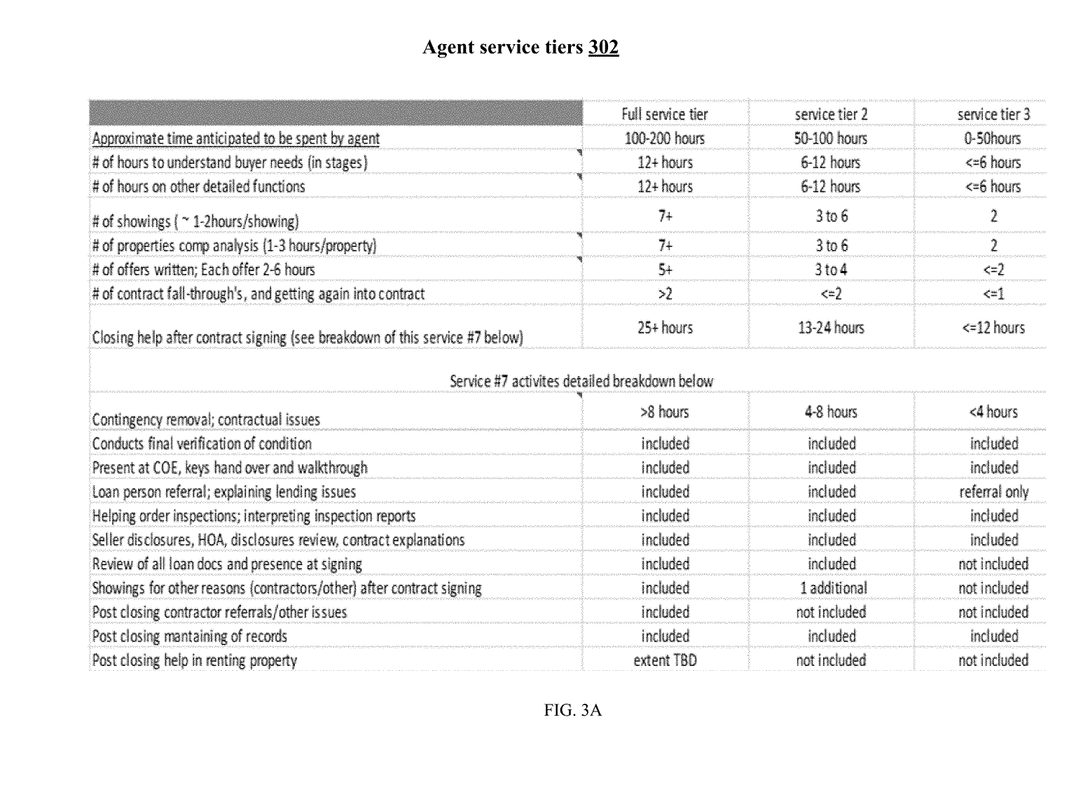

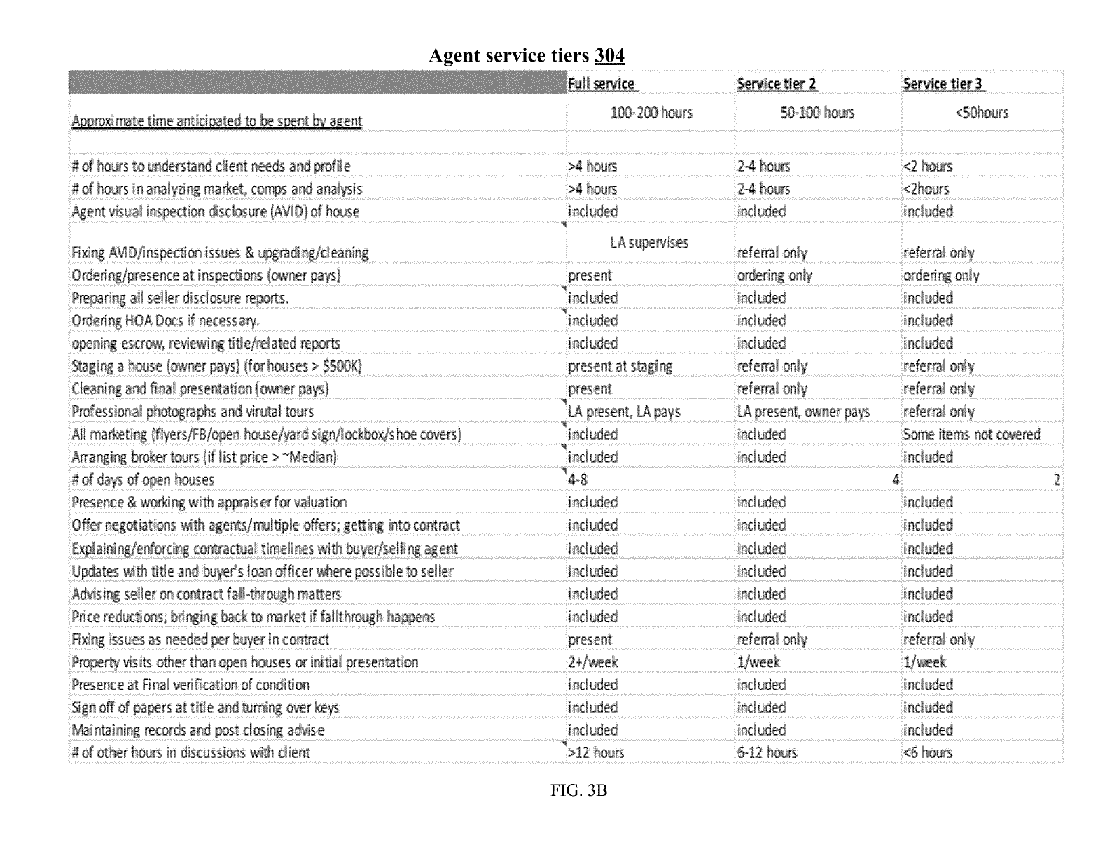

Processor(s) 104 can include one or more processing units (also sometimes called CPUs or processors or microprocessors or microcontrollers) configured to execute instructions in one or more programs and/or instructions stored in memory 106 and thereby performing processing operations. Memory 106 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 106 optionally includes one or more storage devices remotely located from processor(s) 104. Memory 106, or alternately the non-volatile memory device(s) within memory 106, comprises a non-transitory computer readable storage medium. In some embodiments, memory 106, or the computer readable storage medium of memory 106 stores the following programs, modules, and data structures, or a subset thereof:
a. Relevant information 108 that can include, among other data input by user:
   i. User contact 110-1 that in some embodiments includes physical address of user, business or personal telephone contact of user, e-mail correspondence of user, and business address of user, to name a few.
   ii. Transaction profile 110-2 that in some embodiments includes physical location of real property and/or tangible personal property, desired price for sale or purchase, timeframe and reasons for sale or purchase, type & details of property (e.g., in the case of real estate: single family, townhome, condo, multifamily, land, mobile home, number of bedrooms, rooms, bathrooms, kitchens, and square footage of property and lot dimensions, school ratings, desired mortgage/tax and insurance levels among many other details), desired commission rate or rebate rate, and desired qualities, qualifications, or characteristics of agent. In some implementations, transaction profile 110-2 can include preferences based on reviews of agent: such as an agent's ability to close fast, an agent's high contract legal knowledge, an agent's high negotiation capability, and an agent's work ethic. In other implementations, transaction profile 110-2 includes a user's reason for entering the market (e.g., user was served notice, user was evicted, user is relocating for a job, user is upgrading a house, or user's child was admitted to a specific school district and user must either leave and rent a new place or find new house). In other implementations, transaction profile 110-2 can include an agreement by the user to be bound by the results of bidding (e.g., “absolute” auction, described below with respect to step 220 of method 200). In other embodiments transaction profiles 110-2 can include a user-defined service tier (e.g., described below with respect to tiers 118).
   iii. Timeframe 110-n that in some embodiments includes window of time for accepting bids, window of time for completion of brokerage transaction, window of time for payments, etc.
b. Agent list 112 that can include, among other data:
   i. Agent contact 114-1 that in some embodiments includes physical address of agent, business or personal telephone contact of agent, e-mail correspondence of agent, and business address of agent, to name a few.
   ii. Registration 114-2 that in some embodiments includes verification of agent qualities, qualifications, or characteristics, such as licensure, education, agent's broker.
   iii. Agent-defined tier (e.g., described below with respect to tiers 118), which includes levels of goods and services provided by a given agent. For example, a particular agent may find one aspect of the exemplar tiers featured in FIGS. 3A-3B unsatisfactory and modify that aspect (e.g., by changing the numerical value of the approximate time to be spent by agent, the first line item in FIG. 3A).
c. Sales record 114-n that in some embodiments includes agent's brokerage transactions completed in a window of time (e.g., in the last year, two years, or four years), value of completed brokerage transactions, reviews of agents (e.g., in some embodiments a feedback mechanism on the agent and the user is provided), and the like.
d. Bids 116 that can include bids submitted by agents, and details of those bids such as associated service tier (described below with respect to tiers 118), and commission rate, rebate rate, qualifications of agent (described above with respect to agent list 112), among other data. In some embodiments, bids 116 can be “absolute” or “reserve” (described below with respect to step 220 of method 200).
e. Tiers 118 that can include multiple levels of goods and services (e.g., in the case of commercial home sales: maximum or minimum number of hours spent by agent on understanding client needs/profile and market analysis; number of property visits per week; agent presence for inspections; number of open houses) or the responsibility for involved costs (e.g., agent is responsible for payment of professional photographers, cleaners, repairs, remodeling). Some examples of a 3-tier service tier model are described below with respect to FIG. 3. In other embodiments, tiers can be defined by users or agents, as described above with respect to relevant information 108 and agent list 112.
f. Characteristics of brokerage transactions 126 can include historical data input by other users (e.g., user-1 though user-n) and data from completed or incomplete brokerage transactions. In many cases a failed brokerage transaction can yield valuable predictive data for analysis, such as an overestimate of value by a user as compared to similar brokerage transaction (e.g., similar transaction profile 110-2, described above). In some embodiments, characteristics of brokerage transactions 126 can include reviews of users or agents (for example, a review, scoring, or assessment, of an agent's ability to close fast, an agent's high contract legal knowledge, an agent's high negotiation capability, and an agent's work ethic). Characteristics of brokerage transactions 126 can include one or more of: the process of identification (e.g., as described below with respect to step 208 of method 200) of users and agents to each other by computer system 100, user input relevant information 108, bids 116, first or second selection of one or more agents (e.g., as described below with respect to optional step 238 of method 200), rejection of one or more or all agents by the user through the bid process described in various implementations here, and the purchase or sale transaction performed on behalf of the user by the selected agent, if any, with another party that the user selects the agent to have a transaction with. For example, in real estate, a buyer may select an agent for representing him on the purchase of a house. In other embodiments characteristics of brokerage transactions 126 includes the details and specifics of any oral or written contract resulting from the systems, methods, and apparatuses described herein.

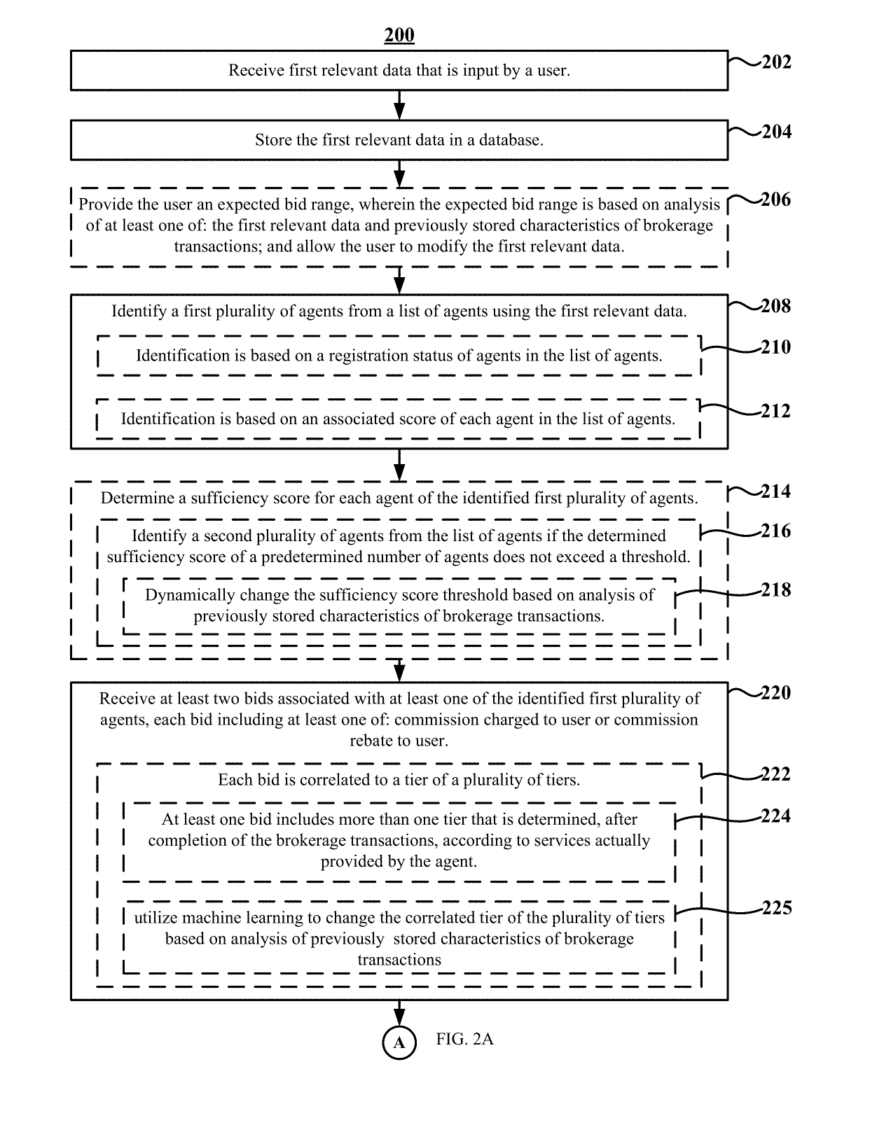

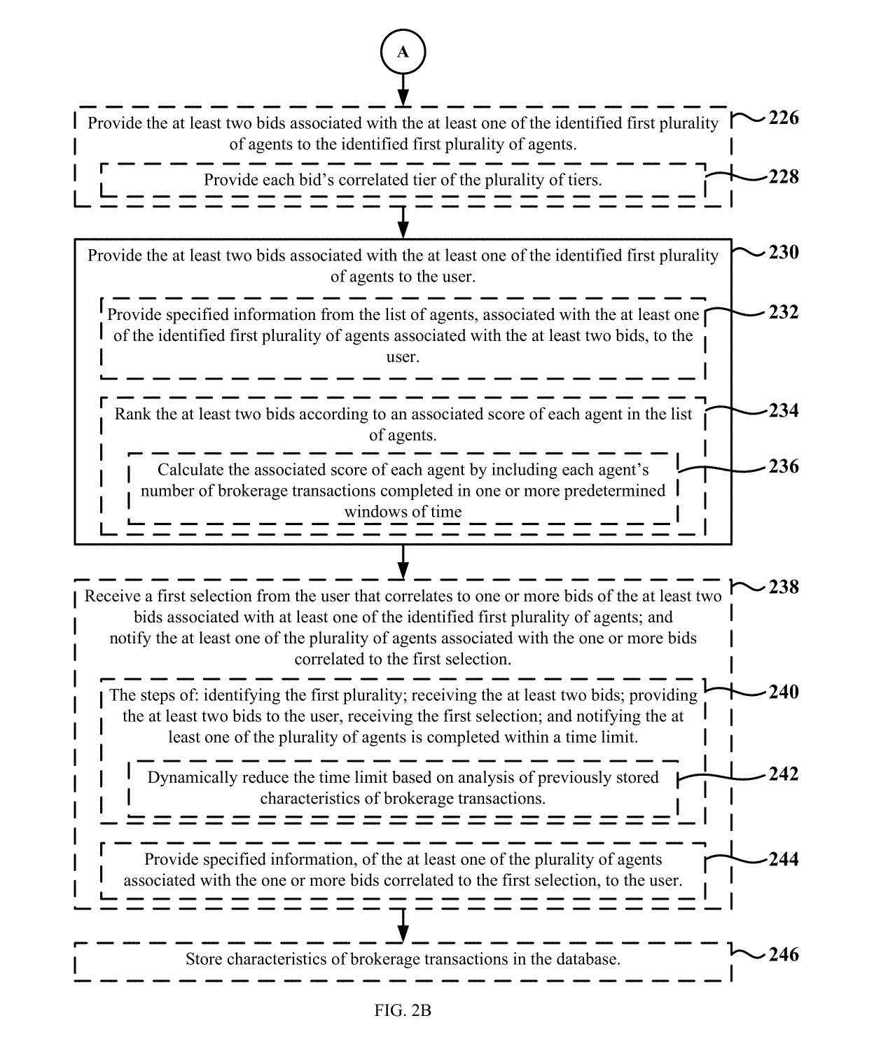

It is understood that while in some embodiments memory 106 stores the above listed programs, modules, and data structures, the list has not been described in exhaustive detail so as not to unnecessarily obscure more pertinent aspects of the implementations described herein, and thus may include additional programs, modules, and data structures. In some embodiments, the programs, modules, and data structures stored in memory 106, or the computer readable storage medium of memory 106, provide instructions for implementing any of the methods described below with reference to FIGS. 2A-2B.

FIGS. 2A-2B illustrate a flowchart representation of a method 200 of improving brokerage transactions, in accordance with some embodiments. At least in some implementations, method 200 is performed by a computer system (e.g., computer system 100, FIG. 1).

First, a server (e.g., server 102, FIG. 1) receives (202) first relevant data (e.g, relevant information 108, FIG. 1) that is input by a user (e.g., user-1, FIG. 1), which initiates performance of method 200. In some embodiments, method 200 is governed by instructions that are stored in a non-transitory computer readable storage medium (e.g., memory 106, FIG. 1) and that are executed by one or more processors of a device, such as the one or more processors 104 of computer system 100, as shown in FIG. 1.

Next, the system stores (204) the first relevant data in a database (e.g., memory 106, FIG. 1). The first relevant data (e.g, relevant information 108, FIG. 1) can include data pertaining to the brokerage transaction a user wishes to engage in. For example, a user may be an individual wishing to sell a private property and relevant data to the sale would include, but not be limited to, contact information for the user (e.g, user contact 110-1, FIG. 1), the physical location and the price (e.g., transaction profile 110-2, FIG. 1), and the time window for completion of the sale (e.g, timeframe 110-n, FIG. 1). Relevant information input by a user is not limited to those examples and can further include, among other data, any variety of details such as a preference for agent qualifications (e.g., a particular agent experience level, agent reviews, agent special skill sets, agents number of brokerage transactions completed, and registration with Agentsdeal Inc.), or associated tiers of services (e.g., tiers 118 as described above with respect to FIG. 1).

Optionally, the system provides (206) the user an expected bid range, wherein the expected bid range is based on analysis of at least one of: the first relevant data (e.g., relevant information 108, FIG. 1) and previously stored characteristics of brokerage transactions (e.g., characteristics of brokerage transactions 126, FIG. 1); and allows the user to modify the first relevant data (e.g., relevant information 108, FIG. 1). In some embodiments the expected bid range is based on computer system 100 analysis of stored data (e.g., in memory 106, FIG. 1) such as the tiers 118 identified by the user, timeframe 110-n for completion of brokerage transaction, transaction profile 110-2 input. This is one implementation but it is understood that the expected bid range can be further modified, changed, or calculated later in method 200 by, for example, analyzing information based off of the agents of the identified first plurality of agents, described below in step 208. In some implementations, user and agent behavior is tracked, stored, and processed, and future behavior is predicted through machine learning (e.g., when exposed to new data, the expected bid range calculation is modified). For example, as data (e.g., transaction profile 110-2, sales record 114-n, characteristics of brokerage transactions 126, as described above with reference to FIG. 1) is gathered (e.g., by crawling databases to collect information (e.g., transaction profile 110-2, sales record 114-n, characteristics of brokerage transactions 126, as described above with reference to FIG. 1)), the analysis for providing an expected bid range is changed because the basis (e.g., the first relevant data and the previously stored characteristics of brokerage transactions) of that analysis has changed, thereby improving the operation of the computer system.

Next, the system identifies (208) a first plurality of agents from a list of agents (e.g., agent list 112, FIG. 1) using the first relevant data (e.g., relevant information 108, FIG. 1). Identification of agents is performed by processors 104 through analysis of data stored in the database (e.g., memory 106, FIG. 1). Data stored in memory 106, as described above with reference to FIG. 1, can include registration 114-2, geographical matching through comparison of user input relevant information 108 (e.g., user contact 110-1 and transaction profile 110-2, FIG. 1) and data stored in the agent list 112 (e.g., agent contact 114-1, registration 114-2, and sales record 114-n, described above with respect to FIG. 1). In some embodiments, the identification of agents includes machine learning, where the identification is based on first relevant data and, as relevant data changes (e.g., by user modification as described above in optional step 206 of method 200), the identification changes because the basis of the identification has changed, thereby improving the operation of the computer system.

Optionally, the identification can be based (210) on a registration status of agents in the list of agents. In some embodiments the method identifies a larger group of agents who may not have registered with the engine. In other embodiments, depending upon number of registered agents, a priority may be given to the registered agents.

In another optional step, the identification is based (212) on an associated score of each agent in the list of agents. In some embodiments agent scores can be stored in a database (e.g., memory 106, FIG. 1). In other embodiments agent scores can be calculated dynamically through analysis of data (e.g., analysis of brokerage transactions 126, described above with respect to FIG. 1). For example, a predefined weight could be attached to various parameters of data, such as those described above with respect to registration status 114-2 and sales record 114-n, of FIG. 1, and combined to improve for preferred agents. In some embodiments the sufficiency score may relate to the number of agents identified in the first plurality that are registered and fall below a threshold number of registered agents. In other embodiments, the sufficiency score may relate to the number of agents identified in the first plurality that are fluent in a language specified by the user in the relevant information. In still other embodiments, the sufficiency score may relate to the number of agents identified in the first plurality that have a certain educational level identified by the user. In yet other embodiments, agent scores can be calculated by including agent reviews (e.g., a review, assessment, or evaluation, of an agent's ability to close fast, an agent's high contract legal knowledge, an agent's high negotiation capability, and an agent's work ethic). In some embodiments, agent scores are calculated by machine learning, where the calculation is changed based on new data. For example, by collecting information (e.g., transaction profile 110-2, sales record 114-n, characteristics of brokerage transactions 126, as described above with reference to FIG. 1) the calculation of agent scores will change as the basis of those calculations changes, thereby improving the operation of the computer system. In some embodiments the method includes predicting agent scores through machine learning. For example, in some embodiments an agent score can be based on statistics obtained by crawling databases (e.g., median prices of property types in a geographical region where agent engages in brokerage transactions or historical data of sales by agent). As another example, agents sometimes operate in multiple geographical areas and an agent score can be weighted differently based on geographical areas where more or fewer data is available. Over time, the stored data (e.g., transaction profile 110-2, sales record 114-n, characteristics of brokerage transactions 126, as described above with reference to FIG. 1) will change, so the calculation of agent score will change because the basis of that calculation has changed, thereby improving the operation of the computer system. It is understood that the preferences and needs of a given user can be wide and varied, and the examples here are not limiting but merely demonstrative or exemplary, and not intended as an exhaustive list.

Optionally, the system determines (214) a sufficiency score for each agent of the identified first plurality of agents. In some embodiments a sufficiency score can be stored or calculated dynamically, as described above with respect to step 212 of method 200.

Optionally, the system identifies (216) a second plurality of agents from the list of agents if the determined sufficiency score of a predetermined number of agents does not exceed a threshold. In some embodiments this enables identification of only qualified agents to the user. In other embodiments the method enables identification of agents with similar range of expertise, experience, and reviews (e.g., by analysis of data stored in agent list 112, such as agent contact 114-1, registration 114-2, and sales record 114-n, described above with respect to FIG. 1). In some embodiments the method can identify a very large number of agents (dozens, hundreds, or more) that a user would be unable to realistically identify and reach out physically on his/her own, or to be able to determine qualified agents who to elicit commission refunds/discounts for the user. In other embodiments the threshold can be calculated through machine learning. For example, the threshold is calculated based off of stored (e.g., stored in memory 106, as described above with respect to FIG. 1) data (e.g., agent list 112, such as agent contact 114-1, registration 114-2, and sales record 114-n, transaction profile 110-2, and characteristics of brokerage transactions 126, described above in reference to FIG. 1). Over time, the stored data will change, so the calculation of the threshold will change because the basis of that calculation has changed, thereby improving the operation of the computer system.

Optionally, when identifying a second plurality of agents, as described above with respect to step 216, the system dynamically (218) changes the sufficiency score threshold based on analysis of previously stored characteristics of brokerage transactions. In some embodiments the threshold is constantly improving through machine learning, by increasing the stored data and analyzing it for more accurate matching of user needs. In other words, in some implementations, the sufficiency score calculation is performed through machine learning. For example, calculation of the threshold is based on data (e.g., transaction profile 110-2, sales record 114-n, characteristics of brokerage transactions 126, as described above with reference to FIG. 1) and as the basis data of the calculation is changed or updated, so does the result of the calculation, thereby improving the operation of the computer system. For example, over time, agent list 112, described above with respect to FIG. 1, will have more data. More data necessarily results in more accurate analysis, prediction, and anticipation of user needs (e.g., the predictive bid described above with respect to step 206), which may result in raising the threshold as more options become available. As an alternate example, if there are insufficient agents identified in the first plurality, the threshold may be lowered, which could result in including agents previously excluded, but also result in serving a user's desire for multiple agents to choose from. In other embodiments, the user may wish to compare a larger or smaller number of bids from agents, or identify only agents above a certain threshold.

Next, system receives (220) at least two bids associated with at least one of the identified first plurality of agents, each bid including at least one of: commission charged to user or commission rebate to user. In the specific case of real estate brokerage transaction, users are typically sellers or buyers. Similarly, agents are typically listing agents, working under a licensed listing broker, or selling agents, working under a licensed selling broker. As such the pricing schema for an agent can be in the form of a commission charged to the sale of a user, or in the form of a rebate repaid from the sale to the user. In some implementations the user can be contractually bound to the best (e.g., the lowest commission rate, or the highest rebate) bid (“absolute” auctions). In other implementations, the user is not contractually bound to any results (“reserve” auctions).

Optionally, the at least two bids received can be correlated (222) to a tier of a plurality of tiers. In some embodiments tiers correspond to different levels of goods and services (e.g., tiers 118, as described above with reference to FIG. 1). In some embodiments there are three tiers with predetermined qualities, as described below with reference to FIGS. 3A-3B). In other embodiments, a service tier can be defined by a user (e.g., as described above with respect to tier 118).

In another optional step, at least one bid includes (224) more than one tier that is determined, after completion of the brokerage transactions, according to services actually provided by the agent. In some cases, an agent does not know the ultimate level of service provided because the level of service is not able to be determined until the conclusion of the brokerage transaction. For example, if a user purchases the first property presented by an agent then different levels of service are involved than if a user purchases a fifth, or fiftieth property. Similarly, an agent selling real estate property for a user may find a listing agent, even before doing any open houses. In some embodiments the total time spent by agent at the completion of the brokerage transaction can determine the service tier. In some embodiments, this flexibility of paying a lower commission, or earning bigger refund of commission, based on actual goods and services provided enables agents to protect themselves from overworking without adequate compensation, and similarly enables users to pay only for goods and services actually received and used. In some implementations this method ensures that agents earn what they spend the effort on, principal sellers pay for only what they use or get, and principal buyers get refunded more for what they do not use.

Optionally, the system utilizes (225) machine learning to change the correlated tier of the plurality of tiers based on analysis of previously stored characteristics of brokerage transactions (e.g., as described below with respect to step 246 of method 200). In some embodiments the correlated tier is changed through machine learning, by increasing the stored data and analyzing it for more accurate matching of goods and services provided or desired. For example, the associated tier is changed based on processing data (e.g., transaction profile 110-2, sales record 114-n, characteristics of brokerage transactions 126, as described above with reference to FIG. 1) and as the basis data of the processing is changed or updated (e.g., by optional step 246 of method 200, described below), so does the result of the calculation, thereby improving the operation of the computer system.

Optionally, the system provides (226) the at least two bids associated with the at least one of the identified first plurality of agents to the identified first plurality of agents. In some embodiments the at least two bids are provided to the identified first plurality of agents in order to facilitate a ‘live’ auction, wherein the bids or a significant portion of the bids would be known by other agents and bids can be placed competitively. In other embodiments, the at least two bids are not provided to the identified first plurality of agents in order to facilitate a ‘private’ auction (sometimes called a silent auction). It is noted that both private and/or live bids can further include absolute or reserve characteristics, as described above with respect to step 220 of method 200 and transaction profile 110-2, FIG. 1).

Optionally, step 226 of method 200 can include providing (228) each bid's correlated tier of the plurality of tiers (e.g., as described above with respect to step 222 and 224 of method 200).

The method 200 continues by providing (230) the at least two bids associated with the at least one of the identified first plurality of agents to the user.

Optionally step 230 of method 200 can include providing (232) specified information from the list of agents (e.g., agent contact 114-1, registration 114-2, and sales record 114-n, FIG. 1), associated with the at least one of the identified first plurality of agents associated with the at least two bids, to the user.

Optionally step 230 of method 200 can include ranking (234) the at least two bids according to an associated score of each agent in the list of agents. In some implementations, ranking can be based upon a sufficiency score, described above with respect to steps 214-218 of method 200. In some embodiments, ranking can be based on agent experience levels, number of transactions closed in a predetermined window of time (e.g., as described below with respect to optional step 236 of method 200), the value of transactions closed in a predetermined window of time (e.g., 6 months, 1 year, 2 years, 4 years, and the lifetime of the agent), and total business an agent has done compared to the median prices in the geographic region that he/she operates in, educational qualification of the agents, real estate honors/certifications achieved, and reviews of other users.

Optionally, step 234 of method 200 can include calculating (236) the associated score of each agent by including each agent's number of brokerage transactions completed in one or more predetermined windows of time. In some embodiments the window of time can be 6 months, 1 year, 2 years, 4 years, or the lifetime of the agent.

Optionally, method 200 includes receiving (238) a first selection from the user that correlates to one or more bids of the at least two bids associated with at least one of the identified first plurality of agents; and notifying the at least one of the plurality of agents associated with the one or more bids correlated to the first selection. In some embodiments the method includes a second or third selection. In some cases, a user may not engage with an agent (e.g., because the agent stops responding, or if the user and agent have incompatibilities such as work schedules, language barriers, or personality clashes) and the method enables the user to make a second, third, and so forth selection. —In some embodiments a selection can include multiple bids that correlate to multiple agents. In other embodiments a selection can include a single agent that has placed multiple bids (e.g., by placing bids on multiple tiers 118, described above with respect to FIG. 1). In some embodiments there may be a limit on number of bids able to be selected by user, which is particularly useful for agents because it protects agents from frivolous selection by user. By requiring users to select a limited number of bids, the user is more likely to limit their choices to those bids that will likely lead to a contract. In some embodiments the selection limit may be adjusted based on consumer behavior. In some implementations the limit is anticipated to be at least 3 and the number of bids is anticipated to be at least 10.

Optionally, the steps of: identifying (208) the first plurality; receiving (220) the at least two bids; providing (230) the at least two bids to the user, receiving (238) the first selection; and notifying the at least one of the plurality of agents is completed (240) within a time limit. In some embodiments the time limit can be set to a small amount (e.g., 48 hours, 24, hours, or less). This provides users with data gathering, analysis, and output within reasonable timeframes. Optionally, in some embodiments the method dynamically reduces (242) the time limit through machine learning, based on analysis of previously stored characteristics of brokerage transactions (e.g., characteristics of brokerage transactions stored in the database, as described below with respect to optional step 246 of method 200). For example, the time limit is changed based on processing data (e.g., transaction profile 110-2, sales record 114-n, characteristics of brokerage transactions 126, as described above with reference to FIG. 1) and as the basis data of the processing is changed or updated (e.g., by optional step 246 of method 200, described below), so does the result of the calculation, thereby improving the operation of the computer system.

Optionally, step 238 of method 200 can include providing (244) specified information (e.g., agent contact 114-1, registration 114-2, and sales record 114-n, described above with respect to FIG. 1), of the at least one of the plurality of agents associated with the one or more bids correlated to the first selection, to the user.

Optionally, method 200 continues by storing (246) characteristics of brokerage transactions in the database. In some embodiments, characteristics of brokerage transactions include all data gathered by method 200 (e.g., receiving (202) and storing (204) first relevant data, receiving (220) bids, described above), all analysis done by method 200 (e.g., identifying (208) pluralities of agents, described above), and all output by method 200 (e.g., providing 230) the at least two bids to the user).

FIGS. 3A-3B illustrate exemplary implementations of graphical representations of different tiers of service (e.g., tiers 118, as described above with respect to FIG. 1) in a given brokerage transaction, in accordance with some embodiments. Agent service tiers 302 corresponds to different combinations of goods and services defined for buyer's (selling) agents and correlated to tiers according to an anticipated three tier system, in some implementations. In other implementations the number of tiers may be more or less than 3, as described above. Agent service tiers 304 corresponds to different combinations of goods and services defined for listing agents and correlated to tiers according to an anticipated three tier system, in some implementations. In other implementations the number of tiers may be more or less than 3, as described above.

It will be understood that, although the terms “first,” “second,” etc. may be used herein to describe various elements, these elements should not be limited by these terms. These terms are only used to distinguish one element from another. For example, a first bid could be termed a second bid, and, similarly, a second bid could be termed a first bid, without changing the meaning of the description, so long as all occurrences of the “first bid” are renamed consistently and all occurrences of the “second bid” are renamed consistently. The first bid and the second bid are both bids, but they are not the same bid.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other additional features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations and embodiments such as the sale of homes. Although specific embodiments have been described and illustrated, the embodiments are not to be limited to the specific forms or arrangements of parts so described and illustrated. Brokerage transactions come in many forms and can cover any type of property (e.g., real property, tangible personal property, and intangible personal property). Many modifications and variations are possible in view of the above teachings. The implementations were chosen and described in order to best explain principles of operation and practical applications, to thereby enable others skilled in the art.

### ALTERNATE EMBODIMENTS

1. Various tiers of services performed (or not performed) by the agent for the principal are defined in service tiers, where in the services that are not explicitly defined, can be encompassed without limitation, as one example by a time limit to perform for extra tasks not defined. Agent commission quotes (discounts/refunds) to principal based on such service tiers that may be optionally negotiated by principal, to result in a broker-principal oral or written, formal or informal, agreement for representation.
   A large number or even a continuous scale of service tiers possible.
   An example 3-tiered service model shown in FIGS. 3A-3B.
   The bid may additionally include optional set of more parameters, for example payment terms expected by agent including agent's minimum experience level, reviews, agent special skill sets, number of transactions.
2. An optional mechanism that adjusts the commission earned based on actual services used in their time and/or quantity based on pre-determined tiers in following way—if requirements change during process of representation, upon such change happening, or at close of transaction when commission is payable or due, the service tier based commission owed can automatically be upgraded or downgraded to a higher or lower services tier discount or refund, if the principal or the agent with principal's knowledge exceeds or under-utilizes the parameters of service specified in the discounted service tier. The bid may additionally include optional set of more parameters, for example payment terms expected by agent including agent's minimum experience level, reviews, agent special skill sets, number of transactions. This to result in a broker-principal oral or written, formal or informal, agreement for representation
   It can be further agreed that such automatic upgrades or downgrades to other service tiers can be bought for an upfront fee or can be free of charge.
3. Computer aided or other bidding platforms that on a principal's request informs multiple agents, at least some of who may bid for commission discount or refund based on one or more service tiers in following ways to result in 1 or more broker-principal oral or written, formal or informal representation agreement
   The bids may additionally include optional set of more parameters, for example payment terms expected by agent including agent's minimum experience level, reviews, agent special skill sets, number of transactions closed or other ways to qualify to an agent as principal may prefer and
   The bids that are made on more than one service tiers can further be agreed upon to be automatically upgraded or downgraded if requirements change during process of representation, upon such change happening, or at close of transaction when commission is payable or due.
   The bids may either be privately to the principal or in a reserve or absolute auction or reverse bid or reverse auction model and bids may be on one or more service tiers and presented to principal in either of following ways.
      i. Private bidding from the agents that may be negotiable by principal
      ii. Reserve auction for agent bids where in at least a portion of all price bids are public to all parties but any or all bids are non-binding on principal and thus further negotiable by principal.
      iii. Absolute auction where in at least a portion of all price bids are disclosed to all parties wherein best and final bid shall be binding on the principal based on pre-set default criterion contractually enforced.
      iv. Reverse bidding where in the principal may specify the commission refund or discount with payment terms along with the service tier and get acceptance of same from multiple agents with varying qualifications, which may be non-binding on the principal.
      v. An “reverse absolute” auction, wherein principal may specify the commission refund or discount with payment terms along with the service tier and get acceptance of same wherein principal has to then accept the bid by the first qualifying agent and is then contractually bound to work with that agent as specified based on a pre-set default criterion contractually enabled on the principal.
4. A feedback mechanism on both the agent and principal provided by each other.

What is claimed:

1. A system for improving brokerage transactions, comprising:
a server, the server electronically connected to a database, the server operative:
receive, input by a user, first relevant data;
store the first relevant data in the database;
identify, using the first relevant data, a first plurality of agents from a list of agents;
receive at least two bids associated with at least one of the identified first plurality of agents, wherein each bid is correlated to a tier of a plurality of tiers and each bid includes at least one of: commission charge to user or commission rebate to user; and
provide the at least two bids associated with the at least one of the identified first plurality of agents to the user.

2. The system of claim 1, wherein the server is further configured to provide the at least two bids associated with the at least one of the identified first plurality of agents to the identified first plurality of agents.

3. The system of claim 1, wherein the server is further configured to:
store characteristics of the brokerage transactions in the database; and
utilize machine learning to change the correlated tier of the plurality of tiers based on analysis of the stored characteristics of brokerage transactions.

4. The system of claim 1, wherein at least one bid, of the received at least two bids, includes more than one tier, wherein upon completion of the brokerage transactions, the tier is determined according to services actually provided by the agent.

5. The system of claim 1, wherein the server is further configured to:
receive a first selection from the user, the first selection correlating to one or more bids of the at least two bids associated with at least one of the identified first plurality of agents; and
notify the at least one of the plurality of agents associated with the one or more bids correlated to the first selection.

6. The system of claim 5, wherein: identifying the first plurality; receiving the at least two bids; providing the at least two bids to the user, and receiving the first selection; and notifying the at least one of the plurality of agents are completed within a time limit.

7. The system of claim 6, wherein the server is further configured to:
store characteristics of the brokerage transactions in the database; and
utilize machine learning to reduce the time limit based on analysis of the stored characteristics of the brokerage transactions.

8. The system of claim 5, wherein the server is further configured to:
provide specified information, of the at least one of the plurality of agents associated with the one or more bids correlated to the first selection, to the user.

9. The system of claim 5, wherein the first selection may be followed by a second selection correlating to one or more bids of the at least two bids associated with at least one of the identified first plurality of agents.

10. The system of claim 1, wherein the server is further configured to:
determine a sufficiency score for each agent of the identified first plurality of agents; and
identify a second plurality of agents from the list of agents if the determined sufficiency score of a predetermined number of agents of the identified first plurality of agents does not exceed a threshold.

11. The system of claim 10, further comprising repeatedly identifying pluralities of agents until a predetermined number of agents of an identified plurality of agents exceeds the threshold.

12. The system of claim 10, wherein the server is further configured to:
store characteristics of the brokerage transactions in the database; and
utilize machine learning to change the sufficiency score threshold based on analysis of the stored characteristics of the brokerage transactions.

13. The system of claim 1, wherein identifying the first plurality of agents is further based upon a registration status of agents in the list of agents.

14. The system of claim 1, wherein identifying the first plurality of agents is further based upon an associated score of each agent in the list of agents.

15. The system of claim 1, wherein the server is further configured to, when providing the at least two bids associated with the at least one of the identified first plurality of agents to the user, to rank the at least two bids according to an associated score of each agent in the list of agents.

16. The system of claim 15, wherein the server is further configured to calculate the associated score of each agent by including each agent's number of brokerage transactions completed in one or more predetermined windows of time.

17. The system of claim 1, wherein the server is further configured to:
store characteristics of the brokerage transactions in the database;
provide the user an expected bid range, wherein the expected bid range is based on analysis of at least one of: the first relevant data and the stored characteristics of the brokerage transactions; and
allow the user to modify the first relevant data.

18. A computer-method to improve brokerage transactions, comprising:
receiving, input by a user, first relevant data;
storing the first relevant data in a database;
identifying, using the first relevant data, a first plurality of agents from a list of agents;
receiving at least two bids associated with at least one of the identified first plurality of agents, wherein each bid is correlated to a tier of a plurality of tiers and each bid includes at least one of: commission charge to user or commission rebate to user; and
providing the at least two bids associated with the at least one of the identified first plurality of agents to the user.

19. The computer-method of claim 18, further comprising providing the at least two bids associated with the at least one of the identified first plurality of agents to the identified first plurality of agents.

20. A system to improve brokerage transactions, comprising:
a server, the server electronically connected to a database, the server operative:
receive, input by a user, first relevant data;
store the first relevant data in the database;
identify, using the first relevant data, a first plurality of agents from a list of agents;
receive at least two bids associated with at least one of the identified first plurality of agents, each bid includes at least one of: commission charge to user or commission rebate to user;
provide the at least two bids associated with the at least one of the identified first plurality of agents to the identified first plurality of agents; and
provide the at least two bids associated with the at least one of the identified first plurality of agents to the user.

21. The system of claim 20, wherein each bid corresponds to a tier of a plurality of tiers, and wherein providing the at least two bids associated with the at least one of the identified first plurality of agents includes providing the corresponding tier.

22. The system of claim 21, wherein at least one bid includes more than one tier, wherein upon completion of the brokerage transactions, the tier is determined according to services actually provided by the agent.

23. The system of claim 21, wherein the server is further configured to:
store characteristics of the brokerage transactions in the database; and
utilize machine learning to change the correlated tier of the plurality of tiers based on analysis of the stored characteristics of brokerage transactions.
